(19) United States
(12) Patent Application Publication
(10) Pub. No.: US 2016/0309950 A1
(43) Pub. Date: Oct. 27, 2016

(54) FILTER ASSEMBLY AND A RESERVOIR FOR AN APPLIANCE

(71) Applicant: General Electric Company, Schenectady, NY (US)

(72) Inventors: Alan Joseph Mitchell, Louisville, KY (US); Ansuraj Seenivasan, Louisville, KY (US)

(21) Appl. No.: 14/696,524

(22) Filed: Apr. 27, 2015

(51) Int. Cl. A47J 31/44; B01D 35/02; B01D 35/30; B01D 24/30

(52) U.S. Cl. CPC A47J 31/44; B01D 24/30; B01D 35/02; B01D 35/30

(57) ABSTRACT

A filter assembly includes a first partition positioned within a filtering chamber of a housing and a second partition mounted to the housing. A biasing mechanism is coupled to the first partition and urges the first partition towards the second partition such that a plurality of activated carbon granules are compression packed against one another within the filtering chamber of the housing. A related reservoir for an appliance is also provided.

### FIELD OF THE INVENTION

The present subject matter relates generally to filter assemblies, such as filter assemblies for appliance reservoirs.

### BACKGROUND OF THE INVENTION

Single serve beverage dispensers (SSBDs) are increasingly popular and have become ubiquitous on kitchen countertops. Certain SSBDs are loaded with capsules or pods that allow users to brew or mix an individual-size, unique, hot or cold beverage. Thus, SSBDs may provide a single cup of coffee to users who do not consume or desire an entire pot of coffee. In order to provide single beverages, SSBDs generally dispense small volumes of liquid (e.g., between eight and sixteen ounces) for each beverage. To permit consecutive preparation of beverages and decrease preparation time, certain SSBDs include a removable storage reservoir. The storage reservoir is generally sized to between four and eight dispenses worth of water therein.

Users commonly fill the storage reservoir with tap water. However, tap water can include various chemicals and/or additives that negatively affect the taste of brewed beverages. For example, chlorine and chloramine are commonly added to tap water by municipalities to act as a biocide and hinder bio-growth within water. Despite its hygienic benefits, users of SSBDs generally prefer the taste of water without chlorine and chloramine. Thus, removal or dissipation of chlorine and chloramine in water within the storage reservoir prior to dispensing the water may improve a taste of the water and an associated beverage.

Certain SSBDs include filters for removing impurities from water within the storage reservoir. For example, activated carbon is commonly formed into blocks to provide a filter for SSBDs. However, the binders required to form activated carbon blocks cover some of the carbon surface area and thereby reduce adsorption capacity of the filter. In addition, activated carbon blocks can be difficult and/or expensive to manufacture.

Accordingly, a reservoir for an appliance that includes features for filtering water from the reservoir would be useful. In particular, a filter that filters water with activated carbon without significantly limiting adsorption capacity of the activated carbon would be useful.

### BRIEF DESCRIPTION OF THE INVENTION

The present subject matter provides a filter assembly. The filter assembly includes a first partition positioned within a filtering chamber of a housing and a second partition mounted to the housing. A biasing mechanism is coupled to the first partition and urges the first partition towards the second partition such that a plurality of activated carbon granules are compression packed against one another within the filtering chamber of the housing. A related reservoir for an appliance is also provided. Additional aspects and advantages of the invention will be set forth in part in the following description, or may be apparent from the description, or may be learned through practice of the invention.

In a first exemplary embodiment, a reservoir for an appliance is provided. The reservoir includes a container having an outlet positioned at a bottom portion of the container. A filter assembly is positioned at the outlet of the container. The filter assembly includes a housing that extends between a first end portion and a second end portion. The housing defines a filtering chamber that extends between the first and second end portions of the housing within the housing. A first partition is positioned within the filtering chamber of the housing at the first end portion of the housing. The first partition is movable relative to housing within the filtering chamber of the housing. A second partition is mounted to the housing at the second end portion of the housing such that the second partition is fixed relative to housing. A plurality of activated carbon granules is disposed within the filtering chamber of the housing. A biasing mechanism is coupled to the first partition. The biasing mechanism urges the first partition towards the second partition within filtering chamber of the housing such that the plurality of activated carbon granules are compression packed against one another within the filtering chamber of the housing.

In a second exemplary embodiment, a filter assembly is provided. The filter assembly includes a housing that extends between a first end portion and a second end portion. The housing defines a filtering chamber that extends between the first and second end portions of the housing within the housing. A first partition is positioned within the filtering chamber of the housing at the first end portion of the housing. The first partition is movable relative to housing within the filtering chamber of the housing. A second partition is mounted to the housing at the second end portion of the housing. The second partition is fixed relative to housing. A plurality of activated carbon granules is disposed within the filtering chamber of the housing. A biasing mechanism is coupled to the first partition. The biasing mechanism urges the first partition towards the second partition within filtering chamber of the housing such that the plurality of activated carbon granules are compression packed against one another within the filtering chamber of the housing.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front, perspective view of a beverage dispenser with a reservoir according to an exemplary embodiment of the present subject matter.

FIG. 2 provides a side, section view of the reservoir and a filter assembly of the exemplary beverage dispenser of FIG. 1.

FIG. 3 provides an exploded view of the filter assembly of FIG. 2.

FIG. 4 provides a partial, section view of the filter assembly of FIG. 2.

FIG. 5 provides a section view of filter assembly according to another exemplary embodiment of the present subject matter.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

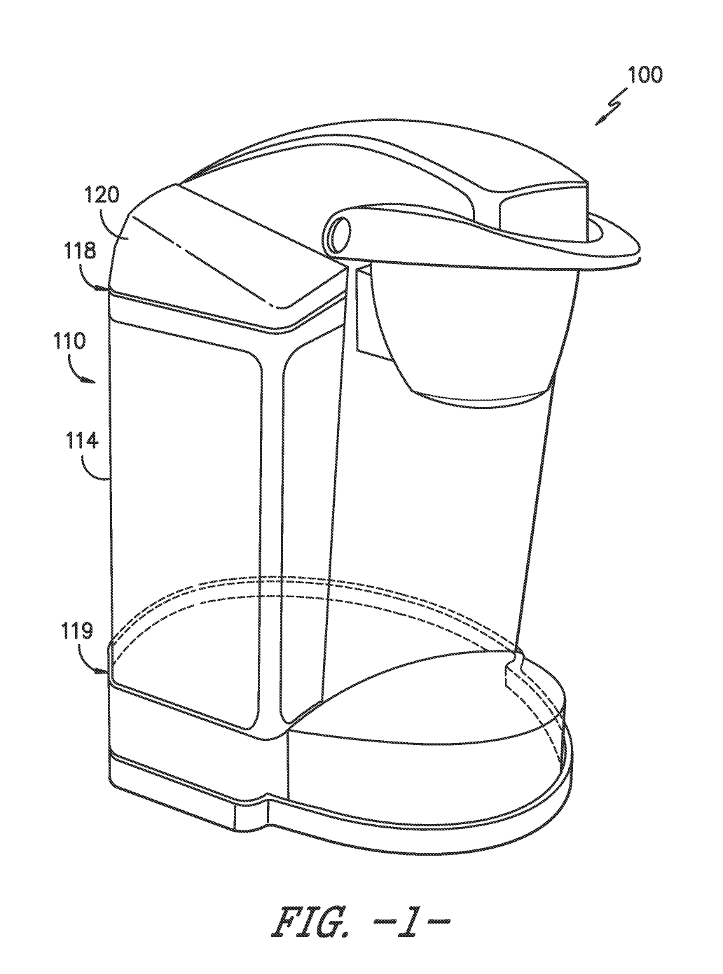

FIG. 1 provides a front, perspective view of a beverage dispenser 100 having a tank or reservoir 110. Beverage dispenser 100 is generally referred to as a “single serve beverage dispenser” and receives capsules or pods with flavorings therein that are brewed or mixed with hot or cold water to provide a hot or cold beverage. As an example, beverage dispenser 100 may be a KEURIG® brand single-cup coffee brewing system or a VERISMO™ brand single-cup coffee brewing system. Thus, while described below in the context of beverage dispenser 100. It should be understood that the subject matter described in greater detail below may be used with any other suitable beverage dispenser having a reservoir in alternative exemplary embodiments.

As discussed above, beverage dispenser 100 includes reservoir 110. Reservoir 110 of beverage dispenser 100 is configured for storing a volume of water therein. Water within reservoir 110 may be drawn out of reservoir 110 and utilized to a brew a beverage during operation of beverage dispenser 100, as will be understood by those skilled in the art. As an example, reservoir 110 may be sized for storing at least thirty-two fluid ounces therein.

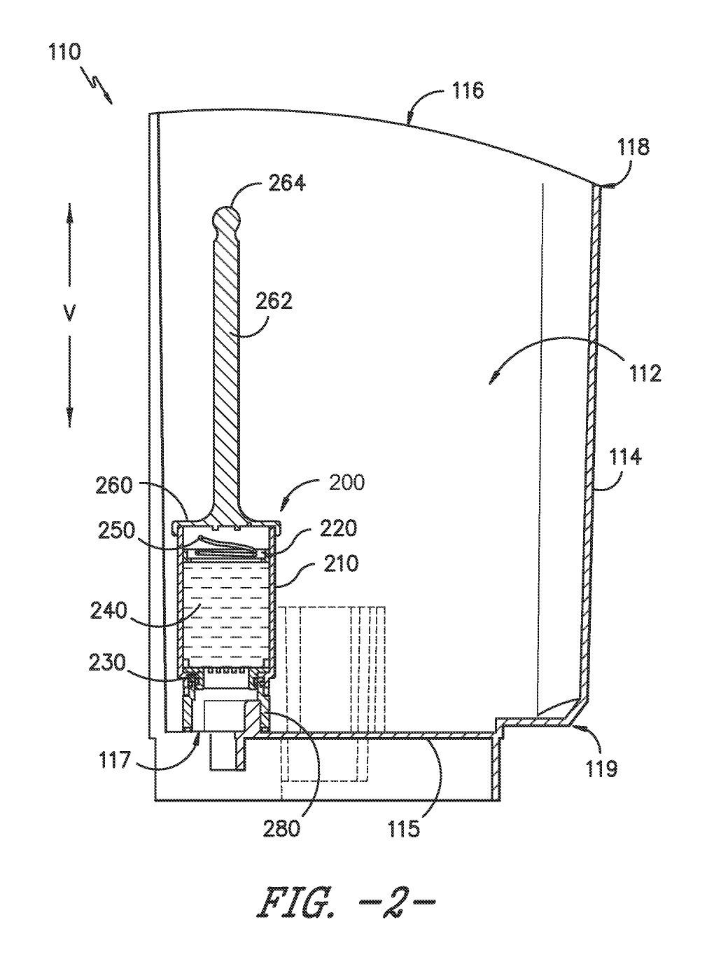

FIG. 2 provides a side, section view of reservoir 110 and a filter assembly 200 positioned within reservoir 110. As discussed in greater detail below, filter assembly 200 filters liquid flowing from reservoir 110 to beverage dispenser 100, e.g., prior to brewing a beverage with the liquid. Thus, filter assembly 200 is discussed in greater detail below in the context of reservoir 110 and beverage dispenser 100. However, it should be understood that filter assembly 200 may be used to filter any other suitable flow of liquid in alternative exemplary embodiments.

As may be seen in FIG. 2, reservoir 110 defines a storage volume 112 that is configured for receiving and storing a volume of liquid therein. In particular, reservoir 110 includes a side wall 114 and a bottom wall 115. Side wall 114 of reservoir 110 extends upwardly from bottom wall 115 along a vertical direction V, and inner surfaces of side wall 114 and bottom wall 115 assist with defining storage volume 112 within reservoir 110.

Reservoir 110 also extends between a top portion 118 and a bottom portion 119, e.g., along the vertical direction V. Reservoir 110 (e.g., side wall 114 of reservoir 110) defines an opening 116 at or adjacent top portion 118 of reservoir 110. A user may fill storage volume 112 of reservoir 110 by directing a flow of liquid into storage volume 112 through opening 116 at top portion 118 of reservoir 110. As may be seen in FIG. 1, a cover 120 may be mounted to reservoir 110 at top portion 118 of reservoir 110, e.g., such that cover 120 is positioned over and covers storage volume 112 of reservoir 110. Reservoir 110 (e.g., bottom wall 115 of reservoir 110) also defines an outlet 117 at or adjacent bottom portion 119 of reservoir 110. Liquid within storage volume 112 of reservoir 110 may be drained from storage volume 112 via outlet 117 at bottom portion 119 of reservoir 110. In particular, gravity may urge liquid within storage volume 112 of reservoir 110 through outlet 117.

Beverage dispenser 100 also includes a filter assembly 200. Filter assembly 200 may be positioned at outlet 117 of reservoir 110. Filter assembly 200 is configured for filtering a flow of liquid passing through filter assembly 200. Thus, filter assembly 200 may filter liquid flowing out of storage volume 112 via outlet 117.

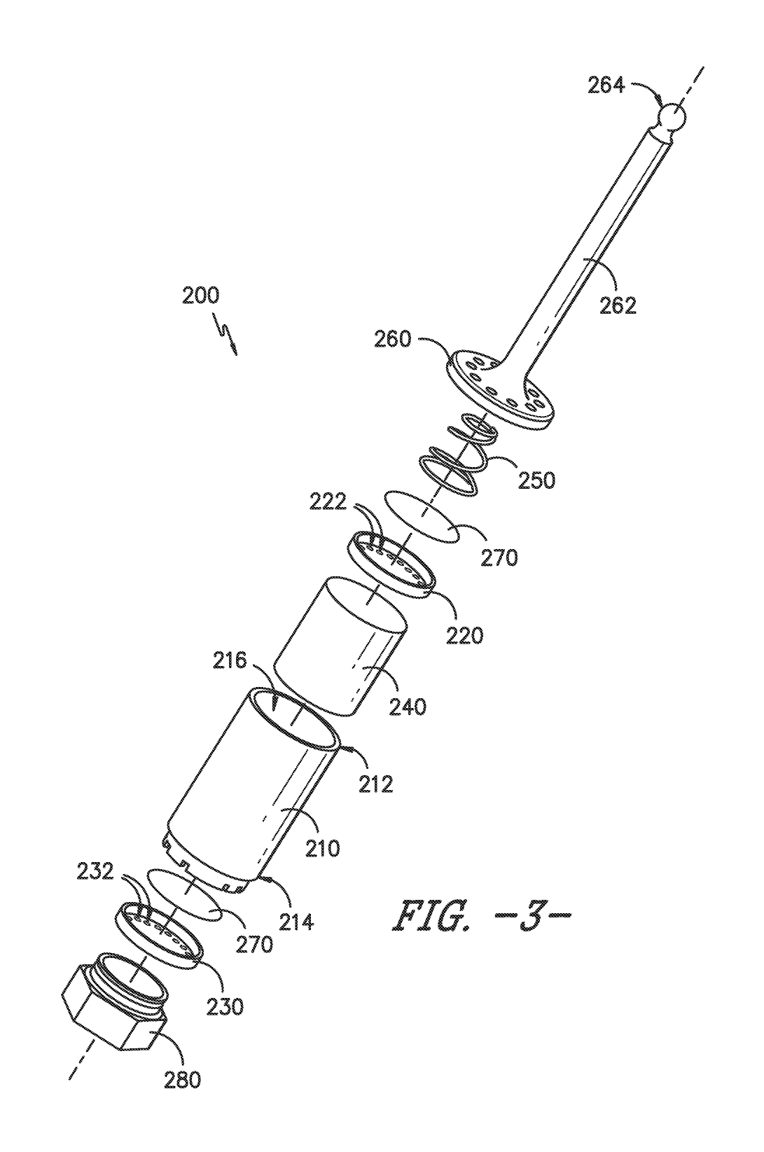

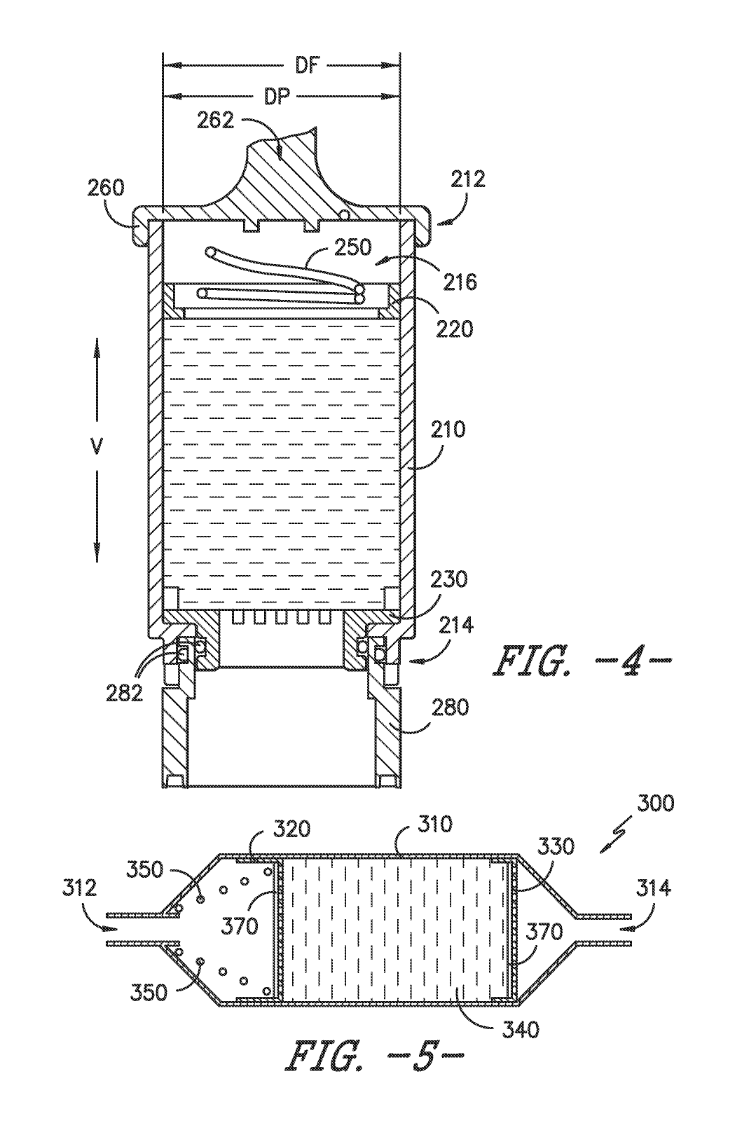

FIG. 3 provides an exploded view of filter assembly 200. FIG. 4 provides a partial, section view of filter assembly 200. As discussed above, while described in greater detail below in the context of beverage dispenser 100, it should be understood that filter assembly 200 may be used to filter any suitable flow of liquid in alternative exemplary embodiments. Thus, filter assembly 200 is not intended to be used only in or with beverage dispenser 100 and is described in the context of beverage dispenser 100 by way of example only.

As may be seen in FIGS. 3 and 4, filter assembly 200 includes a housing 210. Housing 210 extends between a first end portion 212 and a second end portion 214. Thus, first and second end portions 212, 214 of housing 210 may be positioned opposite each other about housing 210. Housing 210 also defines a filtering chamber 216 therein. Filtering chamber 216 of housing 210 may extend between first and second end portions 212, 214 of housing 210 within housing 210. Housing 210 may also have a cylindrical shape and may be open at first and second end portions 212, 214 of housing 210, in certain exemplary embodiments.

Filter assembly 200 may be mounted to reservoir 110 at or adjacent second end portion 214 of housing 210. In particular, as shown in FIG. 2, a bracket 280 mounted to housing 210 at second end portion 214 of housing 210 couples filter assembly 200 to reservoir 110 at outlet 117 of reservoir 110. In addition, O-rings 282 may extend between bracket 280 and housing 210, e.g., in order to block unfiltered liquid from storage volume 112 of reservoir 110 from bypassing filter assembly 200 and exiting storage volume 112 of reservoir 110 at outlet 117.

Turning back to FIGS. 3 and 4, filter assembly 200 also includes a first partition 220 and a second partition 230. First partition 220 is positioned or disposed within filtering chamber 216 of housing 210, e.g., at or adjacent first end portion 212 of housing 210. First partition 220 is movable or slidable relative to housing 210 within filtering chamber 216 of housing 210. Thus, first partition 220 is not fixed to housing 210. First partition 220 also defines a plurality of holes 222. Holes 222 of first partition 220 permit liquids to flow through first partition 220, e.g., into filtering chamber 216 of housing 210. First partition 220 may be shaped to match or complement a cross-sectional area of filtering chamber 216 of housing 210. For example, first partition 220 may be round, and a diameter DP of first partition 220 may be about (e.g., within ten percent of) equal to a diameter DF of filtering chamber 216 of housing 210.

Second partition 230 is mounted to housing 210, e.g., at or adjacent second end portion 214 of housing 210. Thus, first and second partitions 220, 230 may be positioned at opposite sides of housing 210. Second partition 230 may be mounted to housing 210 such that second partition 230 is fixed relative to housing 210. Thus, second partition 230 may not move relative to housing 210 when second partition 230 is mounted to housing 210. Second partition 230 also defines a plurality of holes 232. Holes 232 of second partition 230 permit liquids to flow through second partition 230, e.g., out of filtering chamber 216 of housing 210.

Filter assembly 200 further includes a plurality of activated carbon granules 240. Activated carbon granules 240 are disposed within filtering chamber 216 of housing 210 and act as a filter medium for liquid flowing through filtering chamber 216 of housing 210. As discussed in greater detail below, activated carbon granules 240 are compacted within housing 210 and are not mounted or fixed to one another. Thus, e.g., filter assembly 200 does not include a plastic binder that secures the granules of activated carbon granules 240 together. Rather, housing 210, first partition 220 and second partition 230 may cooperate to compress and hold activated carbon granules 240 within filtering chamber 216 of housing 210, as discussed in greater detail below.

As may be seen in FIG. 4, filter assembly 200 includes a biasing mechanism 250 that is coupled to first partition 220. Biasing mechanism 250 urges first partition 220 into filtering chamber 216 of housing 210, e.g., and towards second partition 230 within filtering chamber 216 of housing 210. Thus, biasing mechanism 250 compression packs activated carbon granules 240 against one another within filtering chamber 216 of housing 210 with first partition 220.

By utilizing biasing mechanism 250 to compression pack activated carbon granules 240, micro-channeling of liquid through activated carbon granules 240 can be reduced or limited relative to unpacked or loose activated carbon granules. Further, compression packing activated carbon granules 240 within housing 210 may improve an adsorption capacity of activated carbon granules 240 relative to activated carbon blocks where a binder limits the adsorption capacity. In addition, compression packing activated carbon granules 240 within housing 210 may assist with allowing use of filter assembly 200 in gravity feed filtration systems, e.g., as shown in FIG. 2. In such a manner, filtering of filter assembly 200 may be improved, e.g., relative to activated carbon blocks with a binder and/or filtration with loose activated carbon granules.

Filter assembly 200 further includes a pair of porous sheets 270. A first one of porous sheets 270 is positioned on first partition 220 at holes 222 of first partition 220, and a second one of porous sheets 270 is positioned on second partition 230 at holes 232 of second partition 230. Porous sheets 270 assist with holding activated carbon granules 240 within filtering chamber 216 of housing 210 while permitting liquids to flow through filtering chamber 216 of housing 210. Porous sheets 270 may be any suitable type or combination of porous sheets that permit liquids to flow therethrough. For example, porous sheets 270 may be filter paper sheets, mesh sheets, woven screens, melt blown polypropylene sheets, etc.

A cap 260 is fixed to housing 210 at first end portion 212 of housing 210. As shown in FIG. 4, biasing mechanism 250 may be a spring that extends between cap 260 and first partition 220 at first end portion 212 of housing 210. Filter assembly 200 may also include a handle 262. As shown in FIG. 2, handle 262 may extend from cap 260 towards top portion 118 of reservoir 110 within storage volume 112 of reservoir 110.

FIG. 5 provides a section view of a filter assembly 300 according to another exemplary embodiment of the present subject matter. Filter assembly 300 is constructed similarly to filter assembly 200 (FIG. 3) and includes similar components. However, filter assembly 300 is configured for filtering a flow of pressurized liquid. As may be seen in FIG. 5, filter assembly 300 includes a housing 310, a non-stationary partition 320, a fixed partition 330, activated carbon granules 340, a compression spring 350 and porous sheets 370. Housing 310 of filter assembly 300 includes an inlet conduit 312 and an outlet conduit 314 for directing a flow of pressurized liquid through housing 310 and activated carbon granules 340 within housing 310.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A reservoir for an appliance, comprising:
a container having an outlet positioned at a bottom portion of the container;
a filter assembly positioned at the outlet of the container, the filter assembly comprising
a housing extending between a first end portion and a second end portion, the housing defining a filtering chamber that extends between the first and second end portions of the housing within the housing;
a first partition positioned within the filtering chamber of the housing at the first end portion of the housing, the first partition being movable relative to housing within the filtering chamber of the housing;
a second partition mounted to the housing at the second end portion of the housing such that the second partition is fixed relative to housing;
a plurality of activated carbon granules disposed within the filtering chamber of the housing; and
a biasing mechanism coupled to the first partition, the biasing mechanism urging the first partition towards the second partition within filtering chamber of the housing such that the plurality of activated carbon granules are compression packed against one another within the filtering chamber of the housing.

2. The reservoir of claim 1, wherein the plurality of activated carbon granules are not fixed to each other with a binder.

3. The reservoir of claim 1, further comprising a cap fixed to the housing at the first end portion of the housing, the biasing mechanism extending between the cap and the first partition at the first end portion of the housing.

4. The reservoir of claim 3, wherein the biasing mechanism comprises a spring.

5. The reservoir of claim 3, further comprising a handle that extends from the cap towards a top portion of the container within the container.

6. The reservoir of claim 5, wherein the filter assembly is mounted to the container adjacent the second end portion of the housing.

7. The reservoir of claim 1, wherein the first and second partitions each define a respective plurality of holes for directing water through the first and second partitions.

8. The reservoir of claim 6, further comprising a pair of porous sheets, a first one of the pair of porous sheets positioned at the plurality of holes of the first partition and a second one of the pair of porous sheets positioned at the plurality of holes of the second partition.

9. The reservoir of claim 1, wherein the housing is a cylindrical housing.

10. The reservoir of claim 9, wherein a diameter of the first partition is about equal to a diameter of the filtering chamber of the housing.

11. A filter assembly, comprising:
a housing extending between a first end portion and a second end portion, the housing defining a filtering chamber that extends between the first and second end portions of the housing within the housing;
a first partition positioned within the filtering chamber of the housing at the first end portion of the housing, the first partition being movable relative to housing within the filtering chamber of the housing;
a second partition mounted to the housing at the second end portion of the housing, the second partition being fixed relative to housing;
a plurality of activated carbon granules disposed within the filtering chamber of the housing; and
a biasing mechanism coupled to the first partition, the biasing mechanism urging the first partition towards the second partition within filtering chamber of the housing such that the plurality of activated carbon granules are compression packed against one another within the filtering chamber of the housing.

12. The filter assembly of claim 11, wherein the plurality of activated carbon granules are not fixed to each other with a binder.

13. The filter assembly of claim 11, further comprising a cap fixed to the housing at the first end portion of the housing, the biasing mechanism extending between the cap and the first partition at the first end portion of the housing.

14. The filter assembly of claim 13, wherein the biasing mechanism comprises a spring.

15. The filter assembly of claim 13, further comprising a handle that extends from the cap.

16. The filter assembly of claim 11, wherein the first and second partitions each define a respective plurality of holes for directing water through the first and second partitions.

17. The filter assembly of claim 11, further comprising a pair of porous sheets, a first one of the pair of porous sheets positioned at the plurality of holes of the first partition and a second one of the pair of porous sheets positioned at the plurality of holes of the second partition.

18. The filter assembly of claim 11, wherein the housing is a cylindrical housing.

19. The filter assembly of claim 18, wherein a diameter of the first partition is about equal to a diameter of the filtering chamber of the housing.
